(19) United States
(12) Patent Application Publication
(10) Pub. No.: US 2012/0319644 A1
(43) Pub. Date: Dec. 20, 2012

(54) CONTACTLESS CHARGING SYSTEM

(76) Inventors: Chih-Kuei Hu, Jubei (TW); Wei-Ting Liu, Hacienda Heights, CA (US); Wei-Hua Lu, Taipei (TW)

(21) Appl. No.: 13/160,549

(22) Filed: Jun. 15, 2011

(51) Int. Cl. H02J 7/00

(52) U.S. Cl. 320/108

(57) ABSTRACT

A contactless charging system comprises a charger, a vehicle and a controller. The charger comprises a power supply for providing a first electric power; a first transmitter electrically connected to the power supply and transforming the first electric power into a first electromagnetic energy; and a second transmitter electrically connected to the power supply and transforming the first electric power into a second electromagnetic energy. The vehicle comprises a receiver placed nearby the first transmitter and the second transmitter, for contactlessly receiving the first electromagnetic energy or the second electromagnetic energy, and transforming the first electromagnetic energy or the second electromagnetic energy into a second electric power; and a battery assembled in the vehicle and electrically connected to the receiver for storing the second electric power. The controller selectively enables the first transmitter or the second transmitter according to the charging efficiency.

### BACKGROUND OF THE INVENTION

1. Field of the Invention

The invention relates to a contactless charging system, and more particularly, to a contactless charging system capable of efficiently charging the battery of an electric vehicle.

2. Description of the Prior Art

With the rapid progression of technology, the development trend of electronic vehicles is toward low pollution and long driving distance. Furthermore, a battery embedded in the electronic vehicle has become a very challenging design task with a rapidly recovered power system. How to charge the battery in the electronic vehicle efficient and convenient is an important issue in the future.

Please refer to FIG. 1, which is a conventional contactless charging system for an electric vehicle. The contactless charging system 100 includes a charger 102 and an electric vehicle 104. The charger 102 is used for transforming the electric power into the electromagnetic energy. A power receiver 106 is installed in the electric vehicle 104 for transforming the electromagnetic energy into the electric power. The battery 108 installed in the electric vehicle 104 is used for storing the electric power. As shown in FIG. 1, the contactless charging system 100 without power plug or cord is one of the most convenient charging methods of the electronic vehicles.

Nevertheless, the related position between the charger 102 and the power receiver 106 is an essential factor of the charging efficiency of the contactless charging system 100. Users cannot precisely park the electric vehicle into the correct charging position every time, and the power dissipation in the contactless charging system 100 is a fatal issue and makes this kind of charging method inefficient.

### SUMMARY OF THE INVENTION

It is therefore a primary objective of the claimed invention to provide an efficient contactless charging system. The claimed invention reduces power dissipation and makes the contactless charging system popularly excised in the electric vehicles.

An embodiment of the invention discloses a contactless charging system comprising a charger, a vehicle and a controller. The charger comprises a power supply for providing a first electric power; a first transmitter electrically connected to the power supply and is capable of transforming the first electric power into a first electromagnetic energy; and a second transmitter electrically connected to the power supply and is capable of transforming the first electric power into a second electromagnetic energy. The vehicle comprises a receiver placed nearby the first transmitter and the second transmitter, for contactlessly receiving the first electromagnetic energy or the second electromagnetic energy, and transforming the first electromagnetic energy or the second electromagnetic energy into a second electric power; and a battery assembled in the vehicle and electrically connected to the receiver for storing the second electric power. The controller selectively enables the first transmitter or the second transmitter according to a first efficiency between the first transmitter and the receiver and a second efficiency between the second transmitter and the receiver.

Another embodiment of the invention discloses a contactless charging system comprising a charger and a vehicle. The charger comprises a power supply for providing a first electric power; a movable transmitter, originally located at a first position, and electrically connected to the power supply and is capable of transforming the first electric power into an electromagnetic energy; and a controller, for moving the movable transmitter to a second position. The vehicle comprises a receiver placed nearby the transmitter, for contactlessly receiving the first electromagnetic energy or the second electromagnetic energy, and transforming the first electromagnetic energy or the second electromagnetic energy into a second electric power; and a battery assembled in the vehicle and electrically connected to the receiver for storing the second electric power. In this embodiment, a second efficiency between the movable transmitter and the receiver at the second position is better than a first efficiency between the movable transmitter and the receiver at the first position.

A further embodiment of the invention discloses a contactless charging system comprising a charger and a vehicle. The charger comprises a power supply for providing a first electric power; and a transmitter electrically connected to the power supply and is capable of transforming the first electric power into an electromagnetic energy. The vehicle comprises a movable receiver originally located at a first position, for contactlessly receiving the electromagnetic energy, and transforming the electromagnetic energy into a second electric power; a battery assembled in the vehicle and electrically connected to the receiver for storing the second electric power; and a controller, for moving the movable receiver to a second position. In this embodiment, a second efficiency between the transmitter and the movable receiver at the second position is better than a first efficiency between the transmitter and the movable receiver at the first position.

A further embodiment of the invention discloses a contactless charging system comprising a charger, a vehicle and a user interface. The charger comprises a power supply for providing a first electric power; and a transmitter electrically connected to the power supply and is capable of transforming the first electric power into an electromagnetic energy. The vehicle comprises a receiver placed nearby the transmitter, for contactlessly receiving the electromagnetic energy, and transforming the electromagnetic energy into a second electric power; and a battery assembled in the vehicle and electrically connected to the receiver for storing the electric power. The user interface indicates a relative position between the transmitter and the receiver for a user to move the vehicle to an efficient charging position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional contactless charging system according to the prior art.

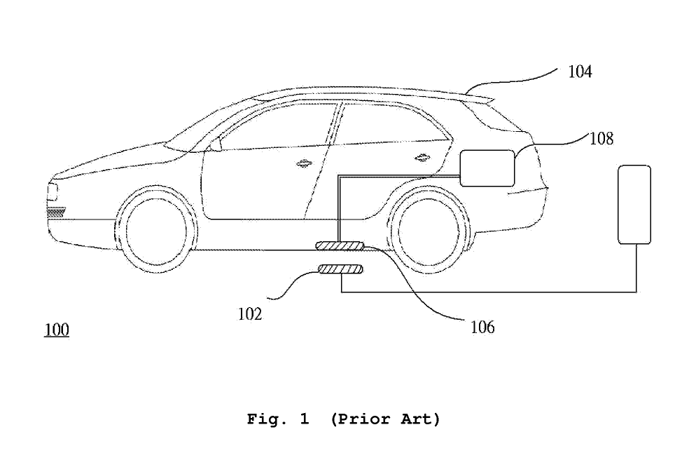

FIG. 2 is a schematic diagram of the first embodiment of the contactless charging system according to the present invention.

FIG. 3 is a top view of the charger according to one embodiment of the present invention.

FIG. 4 is a top view of the charger according to one embodiment of the present invention.

FIG. 5 is a schematic diagram of the second embodiment of the contactless charging system according to the present invention.

FIG. 6 is a top view of the receiver according to one embodiment of the present invention.

FIG. 7 is a top view of the receiver according to one embodiment of the present invention.

FIG. 8 is a schematic diagram of the third embodiment of the contactless charging system according to the present invention.

FIG. 9 is a schematic diagram of the fourth embodiment of the contactless charging system according to the present invention.

FIG. 10 is a schematic diagram of the fifth embodiment of the contactless charging system according to the present invention.

FIG. 11 is a schematic diagram of the user interface according to one embodiment of the present invention.

### DETAILED. DESCRIPTION

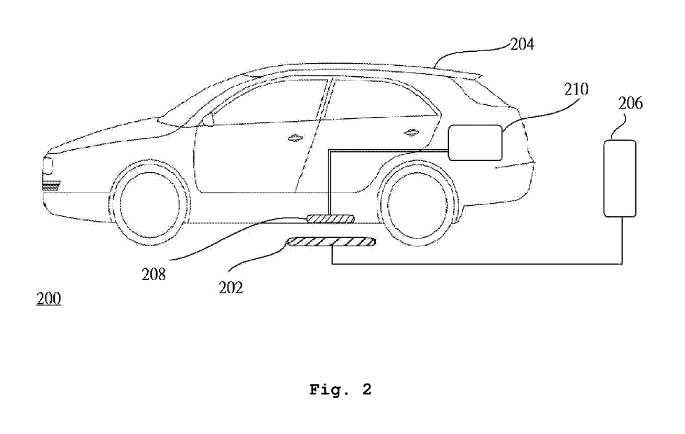

Please refer to FIG. 2, which is a schematic diagram of the first embodiment of the contactless charging system according to the present invention. The contactless charging system 200 includes a charger 202 and a vehicle 204. The charger 202 is used for transmitting electric power from a power supply 206 into the electromagnetic energy, and the power supply 206 can be equipped outside the charger 202, such as FIG. 2 shows, or embedded in the charger 202. A receiver 208 is equipped in the vehicle 204, and the receiver 208 can be induced by the electromagnetic energy and transmit the electromagnetic energy into electric power. A battery 210 is installed in the vehicle 204 for storing the electric power from the receiver 208.

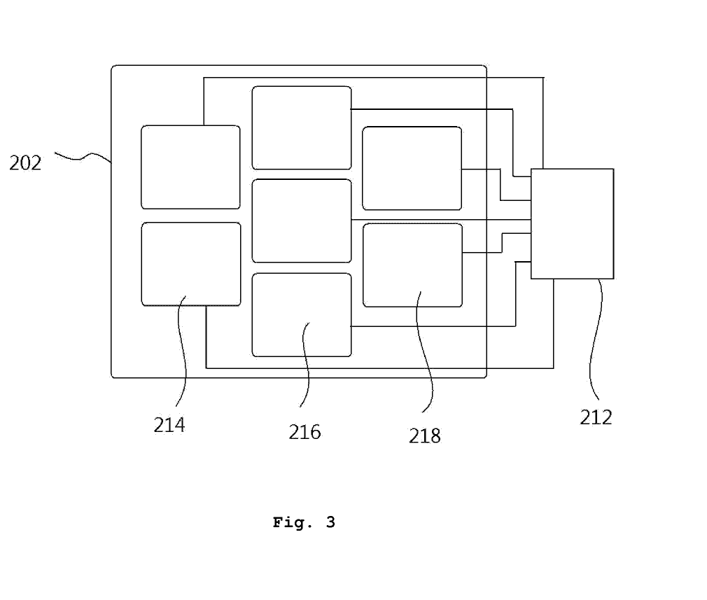

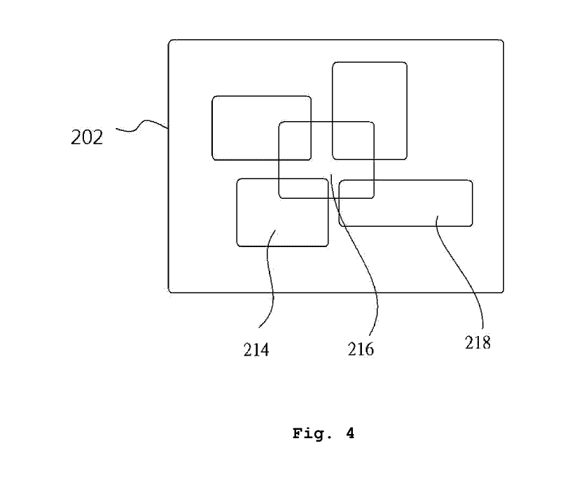

Please refer to FIG. 3, which is a top view of the charger 202 according to the present invention. The charger 202 includes transmitters 214, 216 and 218, and each transmitter is connected to a controller 212. The controller 212 is used for individually or combinatively controlling and switching on/off the transmitters 214, 216 and 218, and monitoring the induction efficiency between the charger 202 and the receiver 208. The controller 212 can utilize a detector to monitor the induction efficiency, or the detector can be also embedded in the controller 212. The induction efficiency can be determined by monitoring the magnetic field intensity, charging current or charging voltage of the charging system. The amount and the equipped position of the transmitters can be designed upon different requirements. Please refer to FIG. 4 for another example, the transmitters are equipped and overlapped each other. The controller 212 can be equipped outside the charger 202, such as FIG. 3 shows, or embedded in the charger 202. After the vehicle 204 is parked upon or nearby the charger 202, the transmitters 214, 216 and 218 are individually or combinatively switched on/off, and the controller 212 continually monitors the induction efficiency between the charger 202 and the receiver 208 and finds out a most efficient result. For example, the controller 212 initially switches on the transmitter 214 and monitors the induction efficiency between the charger 202 and the receiver 208, wherein, for example, the induction efficiency by using the transmitter 214 is the first efficiency. Then, the controller 212 switches off the transmitter 214 and then switches on the transmitter 216, and monitors the induction efficiency between the charger 202 and the receiver 208 again and so on, wherein, for example, the induction efficiency by using the transmitter 216 is the second efficiency, and the induction efficiency by using the transmitter 214 and 218 combinatively is the third efficiency. Each transmitter is individually or combinatively controlled and switched on/off to monitor the induction efficiency between the charger 202 and the receiver 208. If the most efficient result is using the transmitter 214 individually (the first efficiency), for example, the controller 212 can enable the transmitter 214 and the transmitter 214 will be used in the charger 202 to induce the receiver 208. The receiver 208 transforms the induced electromagnetic energy into electric power, and charge the battery 210. The receiver 208 can further include a detector for monitoring the induction efficiency between the charger 202 and the receiver 208, and wirelessly transmit the monitoring results to the controller 212.

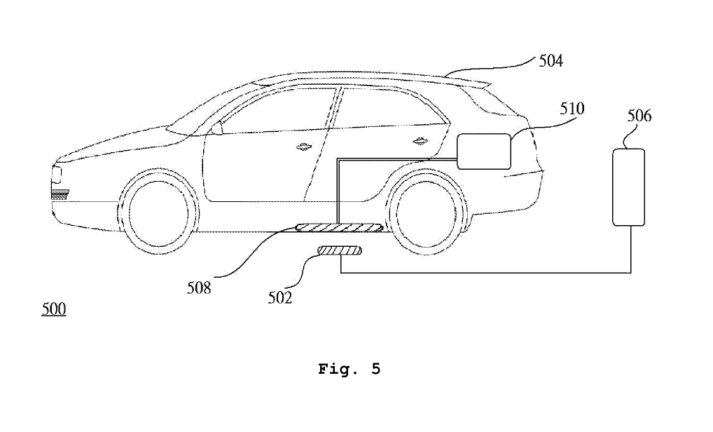

Please refer to FIG. 5, which is a schematic diagram of the second embodiment of the contactless charging system according to the present invention. The contactless charging system 500 includes a charger 502 and a vehicle 504. The charger 502 is used for transmitting electric power from a power supply 506 into the electromagnetic energy, and the power supply 506 can be equipped outside the charger 502, such as FIG. 5 shows, or embedded in the charger 502. A receiver 508 is equipped in the vehicle 504, and the receiver 508 can be induced by the electromagnetic energy and transmit the electromagnetic energy into electric power. A battery 510 is installed in the vehicle 504 for storing the electric power from the receiver 508.

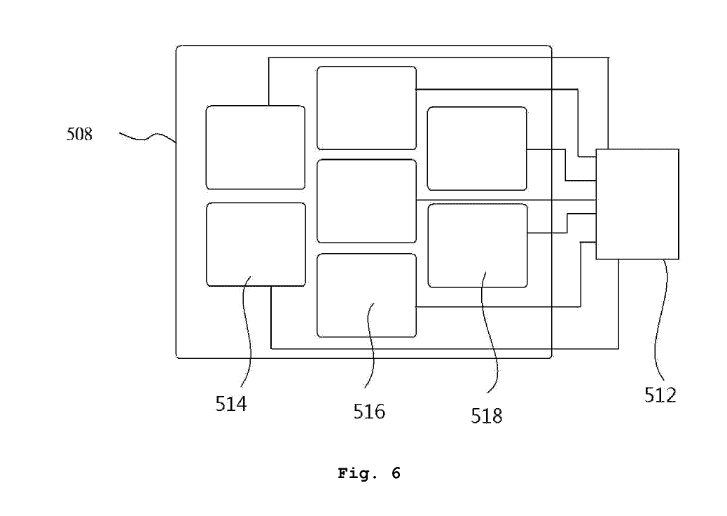

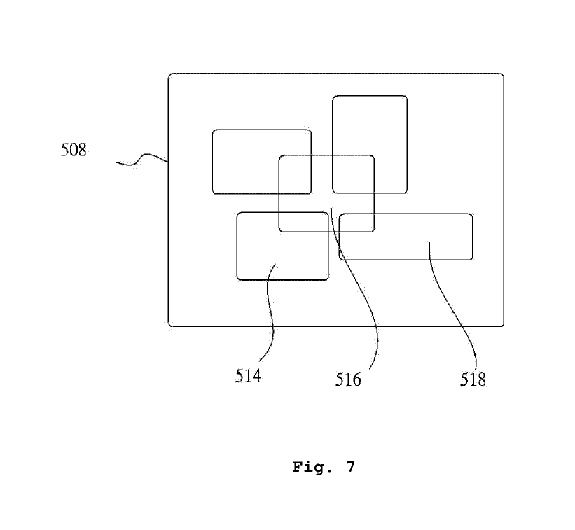

Please refer to FIG. 6, which is a top view of the receiver 508 according to the present invention. The receiver 508 includes inductors 514, 516 and 518, and each inductor is connected to a controller 512. The controller 512 is used for individually or combinatively controlling and switching on/off the inductors 514, 516 and 518, and monitoring the induction efficiency between the charger 502 and the receiver 508. The receiver 508 can utilize a detector to monitor the induction efficiency, or the detector can be also embedded in the receiver 508. The induction efficiency can be determined by monitoring the magnetic field intensity, charging current or charging voltage of the charging system. The amount and the equipped position of the inductors can be designed upon different requirements. Please refer to FIG. 7 for another example, the inductors are equipped and overlapped each other. The controller 512 can be equipped outside the receiver 508, such as FIG. 6 shows, or embedded in the receiver 508. After the vehicle 504 is parked upon or nearby the charger 502, the inductors 514, 516 and 518 are individually or combinatively controlled and switched on/off, and the controller 512 continually monitors the induction efficiency between the charger 502 and the receiver 508 and finds out a most efficient result. For example, the controller 512 initially switches on the inductor 514 and monitors the induction efficiency between the charger 502 and the receiver 508, wherein, for example, the induction efficiency by using the inductor 514 is the first efficiency. Then the controller 512 switches off the inductor 514 and switches on the inductor 516, and monitors the induction efficiency between the charger 502 and the receiver 508 again and so on, wherein, for example, the induction efficiency by using the inductor 516 is the second efficiency, and the induction efficiency by using the inductor 514 and 518 combinatively is the third efficiency. Each inductor is individually or combinatively controlled and switched on/off to monitor the induction efficiency between the charger 502 and the receiver 508. If the most efficient result is using the inductor 514 individually (the first efficiency), for example, the controller 512 can enable the inductor 514 and the inductor 514 will be used in the receiver 508 to receive the electromagnetic energy from the charger 502. The receiver 508 transforms the induced electromagnetic energy into electric power, and charges the battery 510.

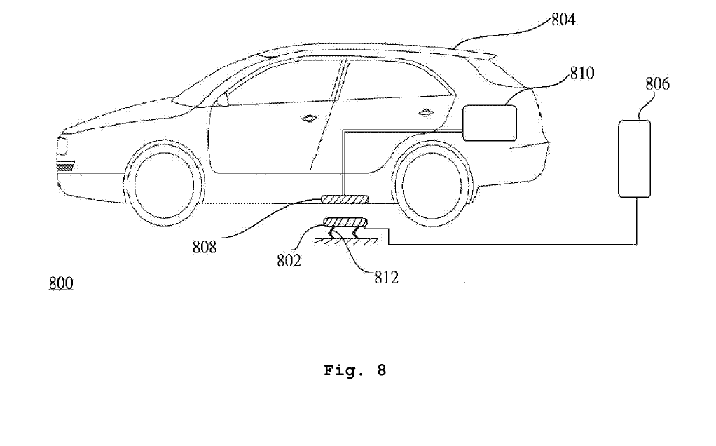

Please refer to FIG. 8, which is a schematic diagram of the third embodiment of the contactless charging system according to the present invention. The contactless charging system 800 includes a charger 802 and a vehicle 804. The charger 802 is used for transmitting electric power from a power supply 806 into the electromagnetic energy, and the power supply 806 can be equipped outside the charger 802, such as FIG. 8 shows, or embedded in the charger 802. A receiver 808 is equipped in the vehicle 804, and the receiver 808 can be induced by the electromagnetic energy and transmit the electromagnetic energy into electric power. A battery 810 is installed in the vehicle 804 for storing the electric power from the receiver 808.

The charger 802 can be driven in one or multiple axes or dimensions to change the charging position. For example, in FIG. 8, the charger 802 is equipped on a moving mechanism 812, and the moving mechanism 812 can move in one or multiple axes and then change the position, slope or height of the charger 802. The contactless charging system 800 includes a controller (not shown in FIG. 8) to control the moving mechanism 812 and monitor the induction efficiency between the charger 802 and the receiver 808. The controller can utilize a detector to monitor the induction efficiency, or the detector can be also embedded in the controller. The induction efficiency can be determined by monitoring the magnetic field intensity, charging current or charging voltage of the charging system. For example, after the vehicle 804 is parked upon or nearby the charger 802, the charger 802 is switched on at a first position and the controller monitors the induction efficiency between the charger 802 and the receiver 808. Then, the charger 802 is driven by the moving mechanism 812 and moved to a second position and the controller monitors the induction efficiency between the charger 802 and the receiver 808 at the second position, and so on. The charger 802 can be moved along a predetermined route to find out a most efficient charging position. Then, the receiver 808 receives the electromagnetic energy from the charger 802, transforms the induced electromagnetic energy into electric power, and charges the battery 810. The receiver 808 can further include a detector for monitoring the induction efficiency between the charger 802 and the receiver 808, and wirelessly transmit the monitoring results to the controller.

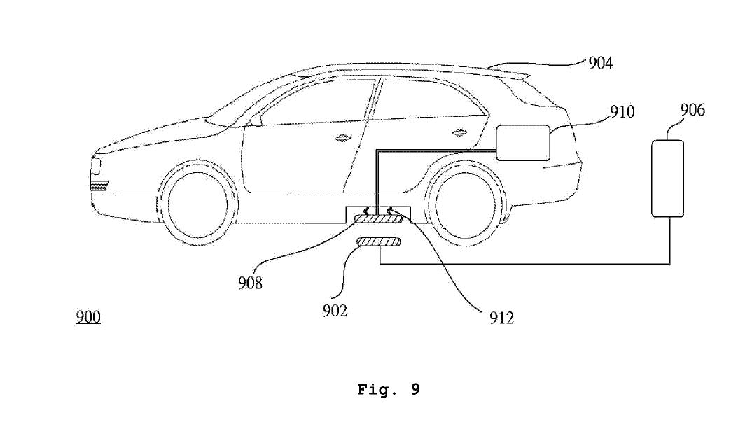

Please refer to FIG. 9, which is a schematic diagram of the fourth embodiment of the contactless charging system according to the present invention. The contactless charging system 900 includes a charger 902 and a vehicle 904. The charger 902 is used for transmitting electric power from a power supply 906 into the electromagnetic energy, and the power supply 906 can be equipped outside the charger 902, such as FIG. 9 shows, or embedded in the charger 902. A receiver 908 is equipped in the vehicle 904, and the receiver 908 can be induced by the electromagnetic energy and transmit the electromagnetic energy into electric power. A battery 910 is installed in the vehicle 904 for storing the electric power from the receiver 908.

The receiver 908 can be driven in one or multiple axes or dimensions to change the charging position. For example, in FIG. 9, the receiver 908 is equipped on a moving mechanism 912, and the moving mechanism 912 can move in one or multiple axes and then change the position, slope or height of the receiver 908. The contactless charging system 900 includes a controller (not shown in FIG. 9) to control the moving mechanism 912 and monitor the induction efficiency between the charger 902 and the receiver 908. The controller can utilize a detector to monitor the induction efficiency, or the detector can be also embedded in the controller. The induction efficiency can be determined by monitoring the magnetic field intensity, charging current or charging voltage of the charging system. For example, after the vehicle 904 is parked upon or nearby the charger 902, the receiver 908 is switched on at a first position and the controller monitors the induction efficiency between the charger 902 and the receiver 908. Then, the receiver 908 is driven by the moving mechanism 912 and moved to a second position and the controller monitors the induction efficiency between the charger 902 and the receiver 908 at the second position, and so on. The receiver 908 can be moved along a predetermined route to find out a most efficient charging position. Then, the receiver 908 receives the electromagnetic energy from the charger 902, transforms the induced electromagnetic energy into electric power, and charges the battery 910.

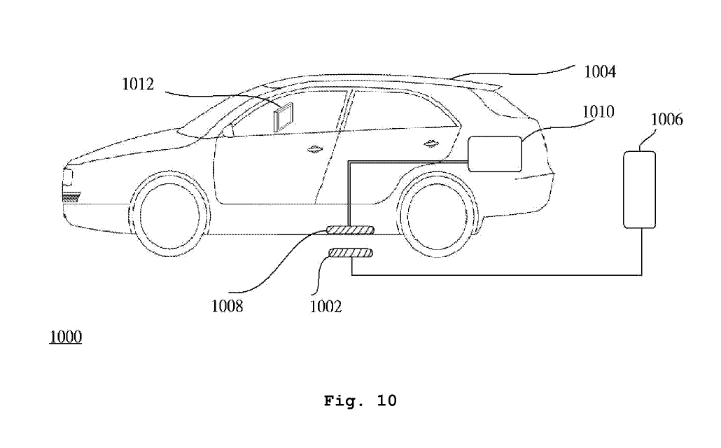

Please refer to FIG. 10, which is a schematic diagram of the fifth embodiment of the contactless charging system according to the present invention. The contactless charging system 1000 includes a charger 1002 and a vehicle 1004. The charger 1002 is used for transmitting electric power from a power supply 1006 into the electromagnetic energy, and the power supply 1006 can be equipped outside the charger 1002, such as FIG. 10 shows, or embedded in the charger 1002. A receiver 1008 is equipped in the vehicle 1004, and the receiver 1008 can be induced by the electromagnetic energy and transmit the electromagnetic energy into electric power. A battery 1010 is installed in the vehicle 1004 for storing the electric power from the receiver 1008. The contactless charging system 1000 also includes a user interface 1012 for indicating the relative position of the charger 1002 and the receiver 1008. When parking the car, users can confirm and adjust the vehicle position.

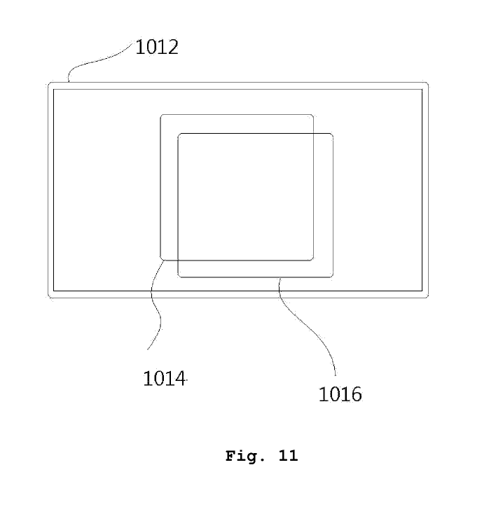

Please refer to FIG. 11, which is a schematic diagram of the user interface 1012. The user interface 1012 can be a screen, a display, a touch panel, sound or light to indicate the relative position of the charger 1002 and the receiver 1008, or to guide the driver to park to the efficient charging position. For example, in FIG. 11, a charger icon 1014 and a receiver icon 1016 are shown on the screen. After the vehicle 1004 is parked upon or nearby the charger 1002, the charger icon 1014 and the receiver icon 1016 will be shown on the user interface 1012 to indicate the relative position of the charger 1002 and the receiver 1008. Users can adjust the parking position to a predetermined efficient charging position according to the indication on the user interface 1012. The relative position of the charger 1002 and the receiver 1008 can be detected by camera, magnetic switches, photo sensor, or any kind of position sensors. The present invention can also utilize sound or light to be the user interface to indicate or guide the driver. For example, sound in different pitches or frequencies can be used to indicate the relative position of the charger and the receiver. When the charger is getting close to the receiver, the frequency of sound will be different.

The position of the charger and the receiver can be also various. In the above embodiments, the charger and the receiver is located under the vehicle. However, other positions, such as side or rear position of the vehicle, can also achieve the concept of the present invention. Those skilled in the art will readily observe that numerous modifications and alterations of the device and method may be made while retaining the teachings of the invention.

What is claimed is:

1. A contactless charging system, comprising:
a charger, comprising:
a power supply for providing a first electric power;
a first transmitter electrically connected to the power supply and is capable of transforming the first electric power into a first electromagnetic energy; and
a second transmitter electrically connected to the power supply and is capable of transforming the first electric power into a second electromagnetic energy;
a vehicle, comprising:
a receiver placed nearby the first transmitter and the second transmitter, for contactlessly receiving the first electromagnetic energy or the second electromagnetic energy, and transforming the first electromagnetic energy or the second electromagnetic energy into a second electric power; and
a battery assembled in the vehicle and electrically connected to the receiver for storing the second electric power; and
a controller, for selectively enabling the first transmitter or the second transmitter according to a first efficiency between the first transmitter and the receiver and a second efficiency between the second transmitter and the receiver.

2. The contactless charging system of claim 1, wherein the first transmitter and the second transmitter are enabled individually.

3. The contactless charging system of claim 1 further comprising a third transmitter electrically connected to the power supply and is capable of transforming the first electric power into a third electromagnetic energy, wherein the first transmitter and the third transmitter are enabled combinatively.

4. The contactless charging system of claim 1, wherein the receiver further comprises a detector for detecting the first efficiency and the second efficiency.

5. The contactless charging system of claim 1, wherein the controller further comprises a detector for detecting the first efficiency and the second efficiency.

6. A contactless charging system, comprising:
a charger, comprising:
a power supply for providing a first electric power;
a transmitter electrically connected to the power supply and is capable of transforming the first electric power into a electromagnetic energy; and
a vehicle, comprising:
a first receiver placed nearby the transmitter, for contactlessly receiving the electromagnetic energy, and transforming the electromagnetic energy into a second electric power;
a second receiver placed nearby the transmitter, for contactlessly receiving the electromagnetic energy, and transforming the electromagnetic energy into a third electric power; and
a battery assembled in the vehicle and electrically connected to the first receiver and the second receiver for storing the second electric power or the third electric power; and
a controller, for selectively enabling the first receiver or the second receiver according to a first efficiency between the transmitter and the first receiver and a second efficiency between the transmitter and the second receiver.

7. The contactless charging system of claim 6, wherein the first receiver and the second receiver are enabled individually.

8. The contactless charging system of claim 6 further comprising a third receiver electrically connected to the battery and is capable of transforming the electromagnetic energy into a fourth electric power, wherein the first receiver and the third receiver are enabled combinatively.

9. The contactless charging system of claim 6, wherein the first receiver and the second receiver further comprises a detector for detecting the first efficiency and the second efficiency.

10. A contactless charging system, comprising:
a charger, comprising:
a power supply for providing a first electric power;
a movable transmitter, originally located at a first position, and electrically connected to the power supply and is capable of transforming the first electric power into an electromagnetic energy; and
a controller, for moving the movable transmitter to a second position;
a vehicle, comprising:
a receiver placed nearby the transmitter, for contactlessly receiving the electromagnetic energy, and transforming the electromagnetic energy into a second electric power; and
a battery assembled in the vehicle and electrically connected to the receiver for storing the second electric power; and
wherein a second efficiency between the movable transmitter and the receiver at the second position is better than a first efficiency between the movable transmitter and the receiver at the first position.

11. The contactless charging system of claim 10, wherein the movable transmitter further comprises a detector for detecting the first efficiency and the second efficiency.

12. The contactless charging system of claim 10, wherein the controller further comprises a detector for detecting the first efficiency and the second efficiency.

13. A contactless charging system, comprising:
a charger, comprising:
a power supply for providing a first electric power; and
a transmitter electrically connected to the power supply and is capable of transforming the first electric power into an electromagnetic energy;
a vehicle, comprising:
a movable receiver originally located at a first position, for contactlessly receiving the electromagnetic energy, and transforming the electromagnetic energy into a second electric power;
a battery assembled in the vehicle and electrically connected to the receiver for storing the second electric power; and
a controller, for moving the movable receiver to a second position; and
wherein a second efficiency between the transmitter and the movable receiver at the second position is better than a first efficiency between the transmitter and the movable receiver at the first position.

14. The contactless charging system of claim 13, wherein the receiver further comprises a detector for detecting the first efficiency and the second efficiency.

15. The contactless charging system of claim 13, wherein the controller further comprises a detector for detecting the first efficiency and the second efficiency.

16. A contactless charging system, comprising:
a charger, comprising:
a power supply for providing a first electric power; and
a transmitter electrically connected to the power supply and is capable of transforming the first electric power into an electromagnetic energy;
a vehicle, comprising:
a receiver placed nearby the transmitter, for contactlessly receiving the electromagnetic energy, and transforming the electromagnetic energy into a second electric power; and
a battery assembled in the vehicle and electrically connected to the receiver for storing the electric power; and
a user interface, for providing an information to guide a user to move the vehicle to an efficient charging position.

17. The contactless charging system of claim 16, wherein the information comprises a transmitter position icon and a receiver position icon related to positions of the transmitter and the receiver.

18. The contactless charging system of claim 16 further comprising a detector to detect the relative position between the transmitter and the receiver.

19. The contactless charging system of claim 16, wherein the detector is a camera or a photo sensor.

20. The contactless charging system of claim 16, wherein the information is a sound or a light for indicating the relative position of the transmitter and the receiver.
